(19) United States
(12) Patent Application Publication
(10) Pub. No.: US 2026/0138636 A1
(43) Pub. Date: May 21, 2026

(54) IDENTIFYING ROAD SEPARATIONS FOR SEMI-AUTONOMOUS AND AUTONOMOUS SYSTEMS AND APPLICATIONS

(71) Applicant: NVIDIA Corporation, Santa Clara, CA (US)

(72) Inventors: Xudong Chen, Sunnyvale, CA (US); Abhishek Bajpayee, Sunnyvale, CA (US); Sai Krishnan Chandrasekar, Santa Clara, CA (US); Siddharth Kothiyal, London (GB); Hae-Jong Seo, Campbell, CA (US)

(21) Appl. No.: 18/941,678

(22) Filed: Nov. 8, 2024

(51) Int. Cl. B60W 60/00; B60W 10/18; B60W 30/12; B60W 30/18; G06V 10/764; G06V 10/82; G06V 20/56

(52) U.S. Cl. CPC B60W 60/001; B60W 10/18; B60W 30/12; B60W 30/18163; G06V 10/764; G06V 20/588; B60W 2552/10; B60W 2552/50; B60W 2552/53; B60W 2554/4044; B60W 2556/40; B60W 2710/18; G06V 10/82

(57) ABSTRACT

In various examples, identifying road separations for semi-autonomous and autonomous systems and applications is described herein. Systems and methods described herein may use various techniques—such as outputs from perception systems and maps—to identify road separations on different types of driving surfaces. For instance, the outputs from a perception system may include at least information describing one or more barriers and one or more road marking located on a driving surface. This information may then be used to determine whether a barrier causes the driving surface to include a divided driving surface—such as when the barrier separates opposing lanes of travel—or a non-divided driving surface—such as when the barrier does not separate the opposing lanes of travel. Systems and methods are then further described that use these determinations to perform one or more operations.

### BACKGROUND

For vehicles or machines (e.g., autonomous vehicles, semi-autonomous vehicles, robots, etc.) to operate safely in environments, the vehicles or machines must be capable of effectively performing semi-autonomous and/or autonomous functions—such as lane keeping, lane changing, lane splits, turns, stopping and starting at intersections, following other vehicles, emergency braking, and/or other vehicle or machine maneuvers. For example, for a vehicle to navigate through surface streets (e.g., city streets, side streets, neighborhood streets, etc.) and on highways (e.g., multi-lane roads), the vehicle is required to navigate within and among one or more divisions or demarcations (e.g., lanes, intersections, crosswalks, boundaries, etc.) of a road that are often marked using road markings—such as solid lines, dashed lines, and/or the like—while also avoiding collisions with other vehicles.

In some circumstances, the types of semi-autonomous and/or autonomous functions that vehicles and/or machines may perform depends on one or more factors, such as the types of roads being navigated. For example, some geographic areas (e.g., countries, etc.) may allow for vehicles to perform specific types of autonomous functions while navigating on certain roads—such as divided highways where there are barriers (e.g., road separations) separating the opposing lanes of traffic—while not allowing the vehicles to perform the same types of autonomous functions on other types of roads—such as highways that do not include such separations. As such, it is important that these vehicles are able to accurately determine the types of roads on which the vehicles are navigating.

Conventionally, to determine the types of roads, the vehicles may use maps—such as navigation maps, standard-definition (SD) maps, and/or high-definition (HD) maps—that indicate road types. However, merely using maps to determine the road types may be insufficient, such as when the maps do not include information about a road being navigated and/or are not updated when road structures change. Additionally, these maps may not include information about the types of barriers being used to separate opposing lanes of traffic, which may be important when determining whether the roads are in fact divided. For example, cone barriers may not qualify as including road separations when determining autonomous functionality, while concrete barriers may qualify as including road separations for the same autonomous functionality.

### SUMMARY

Embodiments of the present disclosure relate to identifying path divisions or separations for semi-autonomous and autonomous systems and applications. Systems and methods described herein may use various techniques—such as outputs from perception systems and/or maps—to identify road or path (e.g., in an indoor or robotics application) separations on different types of driving or navigable surfaces. For instance, the outputs from a perception system may include at least information describing one or more barriers and one or more road markings located on a driving surface. This information may then be used to determine whether a barrier creates a divide or separation in the driving surface (e.g., when the barrier separates opposing lanes of travel (e.g., also referred to as a “road separation”)) or a non-divided driving surface (such as when the barrier does not separate the opposing lanes of travel). In some examples, determining whether the barrier or other divider type separates the opposing lanes of travel may depend on one or more factors, such as the type(s) of barrier(s), the type(s) of road marking(s), and/or laws associated with a geographic area for which a machine is navigating. Systems and methods are then further described that use these determinations to perform one or more operations, such as activating and/or deactivating semi-autonomous and/or autonomous functions of machines.

In contrast to conventional systems, the systems of the present disclosure, in some embodiments, may use the outputs from the perceptions systems to identify and/or verify divided driving surfaces, such as in addition to or alternatively from using a map. As described in more detail herein, using the outputs from the perception systems to identify and/or verify the divided driving surfaces may increase the accuracy of the systems of the present disclosure by still being able to detect divided driving surfaces even when maps are not updated and/or include insufficient information. For example, since determining whether driving surfaces are divided may depend on various factors—such as the types of barriers and/or the geographic areas for which the driving surfaces are located—the systems of the present disclosure are able to use the additional information from the perception systems to determine and/or verify whether the driving surfaces are divided.

### BRIEF DESCRIPTION OF THE DRAWINGS

The present systems and methods for identifying path divisions or separations for semi-autonomous and autonomous systems and applications are described in detail below with reference to the attached drawing figures, wherein:

FIG. 1 illustrates an example data flow diagram for a process of determining whether navigable surfaces include divisions or separations, in accordance with some embodiments of the present disclosure;

FIG. 2 illustrates an example of a divided driving surface that includes a road separation, in accordance with some embodiments of the present disclosure;

FIGS. 3A-3C illustrate examples of determining whether navigable surfaces are divided with dividers or separations, in accordance with some embodiments of the present disclosure;

FIG. 4 illustrates an example of determining whether one or more navigable surfaces include one or more divisions or separations over a period of time, in accordance with some embodiments of the present disclosure;

FIG. 5 illustrates an example of one or more systems that may perform at least a portion of the processes described herein, in accordance with some embodiments of the present disclosure;

FIG. 6 illustrates a flow diagram showing a method for identifying a navigable surface separation associated with a navigable surface, in accordance with some embodiments of the present disclosure;

FIG. 7 illustrates a flow diagram showing a method for determining whether a navigable surface is divided, in accordance with some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

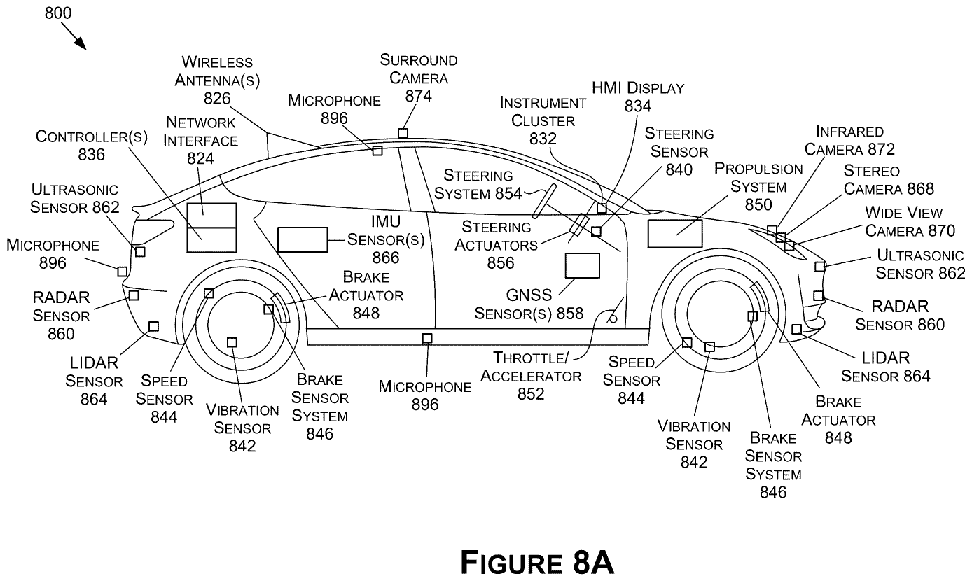

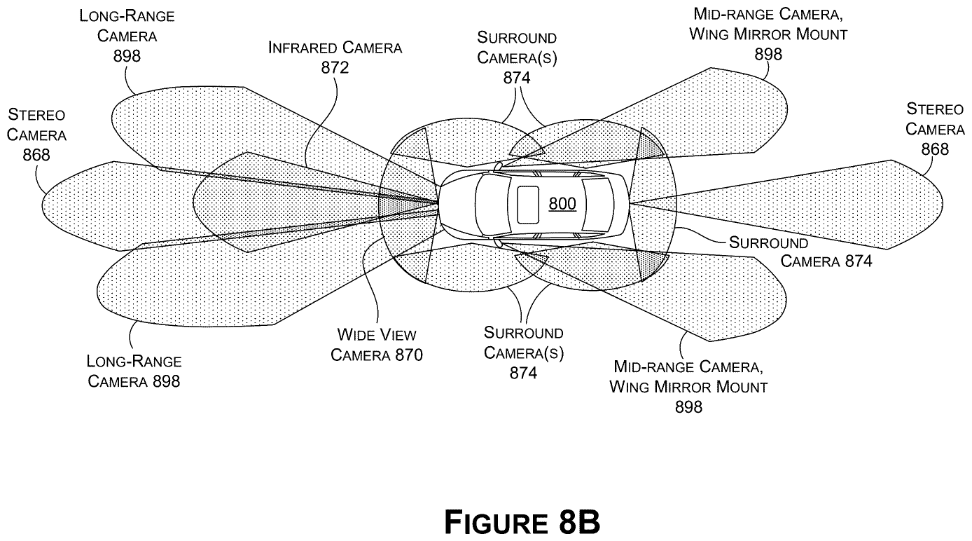

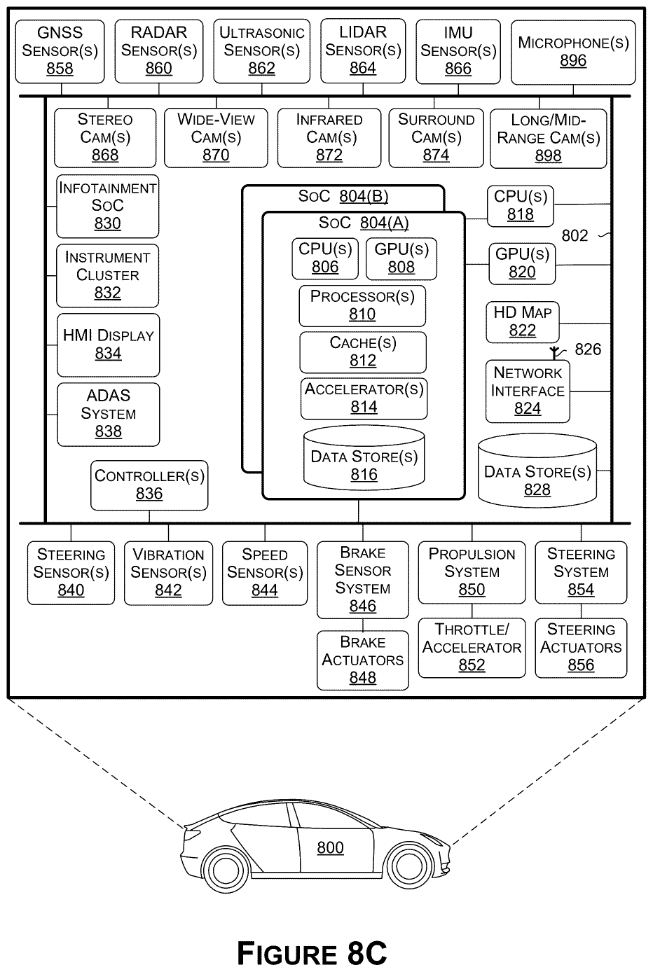

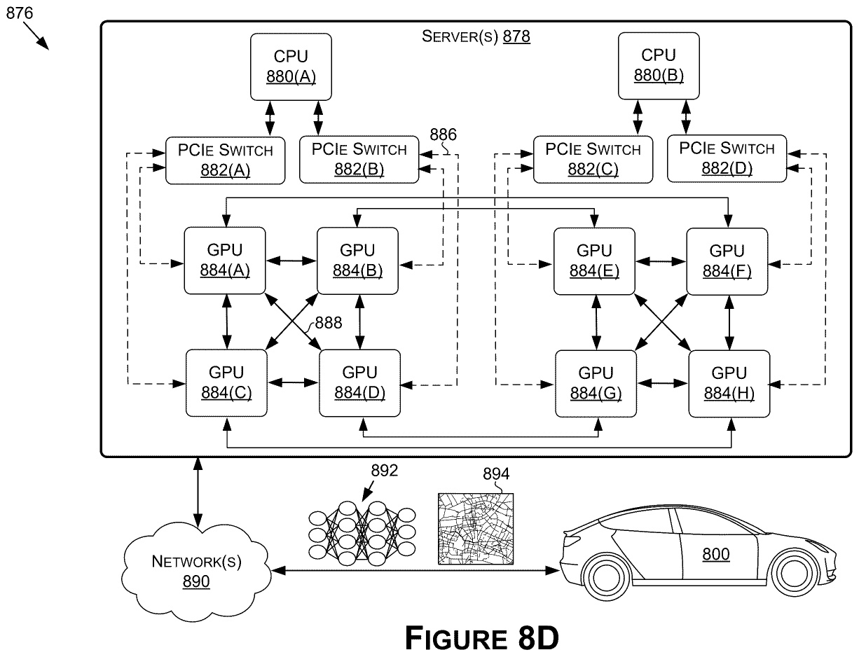

Systems and methods are disclosed related to identifying road separations for semi-autonomous and autonomous systems and applications. Although the present disclosure may be described with respect to an example autonomous or semi-autonomous vehicle or machine 800 (alternatively referred to herein as “vehicle 800,” “ego-vehicle 800,” “ego-machine 800,” or “machine 800,” an example of which is described with respect to FIGS. 8A-8D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to determining whether driving surfaces include road separations, this is not intended to be limiting, and the systems and methods described herein may be used in augmented reality, virtual reality, mixed reality, robotics, security and surveillance, autonomous or semi-autonomous machine applications, and/or any other technology spaces where determining whether navigable surfaces include divisions or separations may be used. For example, although roads for vehicles to navigate may be described primarily, the systems and methods described herein may be used for other navigable surfaces—such as waterways, airspace, warehouses, buildings, parks, etc.—for navigation by other than a vehicle (e.g., a robot (e.g., autonomous mobile robot (AMR), humanoid robot, forklift, etc.), watercraft, a drone, an aircraft, etc.).

For instance, a system(s) may obtain sensor data using one or more sensors of a machine, such as a semi-autonomous and/or autonomous vehicle and/or other type of robot. As described herein, the sensor data may include, but is not limited to, image data obtained using one or more image sensors, LiDAR data obtained using one or more LiDAR sensors, RADAR data obtained using one or more RADAR sensors, and/or any other type of sensor data obtained using any other type of sensor. The system(s) may then process the sensor data using one or more machine learning models—such as one or more machine learning models associated a perception system (and/or other type of system) of the machine—to determine information associated with the driving surface for which the machine is navigating. For instance, in some examples, the information may describe at least one or more barriers and/or one or more road markings associated with the driving surface.

For example, the information associated with a barrier may include, but is not limited to, a type of barrier (e.g., concrete slabs, a guardrail, a curb, cones, a separation area, etc.), one or more dimensions associated with the barrier (e.g., a width, a length, and/or a height of the barrier, etc.), and/or a location of the barrier (e.g., a lateral distance between the machine and the barrier, etc.). Additionally, the information associated with a road marking may include, but is not limited to, a type of road marking (e.g., double line marking, single line marking, dashed marking, solid marking, dotted marking, etc.), a color of the road marking (e.g., white, yellow, etc.), and/or a location of the road marking. In some examples, the system(s) may continue to obtain and process additional sensor data using the machine learning model(s) to determine additional information associated with the barrier(s) and/or the road marking(s). For example, the system(s) may verify whether a barrier exists and/or information associated with the barrier based on outputs from the machine learning model(s) over a period of time.

The system(s) may then use the information to determine whether the driving surface includes a divided driving surface or a non-divided driving surface. As described herein, in some examples, a divided driving surface may include a road separation that separates opposing lanes of traffic while a non-divided driving surface may not include a road separation (or may include a separation that is traversable or otherwise not classified as “non-dividing”) that separates opposing lanes of traffic. Additionally, in some examples, determining whether a driving surface includes a divided driving surface may depend on one or more factors, such as laws associated with a geographic area for which the driving surface is located. For example, some geographic areas may specify that any type of barrier that separates opposing lanes of traffic causes a driving surface to be divided while other geographic areas may specify that specific types of barriers—such as barriers for which machines are unable to traverse—cause a driving surface to be divided. In such an example, types of barriers that machines are unable to traverse may include concrete slabs, guardrails, and/or any other types of barriers that machines may not navigate over, while types of barriers that machines are able traverse may include cones, road separation areas, and/or any other types of barriers that machine may navigate over.

In some examples, the system(s) may use one or more algorithms to determine whether a driving surface is divided using the information (e.g., determine a road separation state, such as a divided state or a non-divided state). For instance, the system(s) may use the information to identify a closest barrier located on at least one side of the machine. The system(s) may then determine that the driving surface is not divided when one or more types of road markings are located between the machine and the closest barrier or determine that the driving surface is divided when the type(s) of road marking(s) is not located between the machine and the closest barrier. As described herein, the type(s) of road marking(s) may be associated with dividing opposing lanes of travel. For example, a type of road marking that indicates non-divided driving surfaces may be associated with separating two-way traffic, such as a double yellow line that separates machines navigating in opposite directions. Additionally, in some examples, the type(s) of road marking(s) may be associated with one or more factors, such as the geographic area for which the machine is navigating.

In some examples, the system(s) may use additional data when determining whether the driving surface is divided. For instance, the system(s) may use map data representing a map of the environment—such as a navigation map, a standard-definition map, and/or a high-definition map—that includes information associated with the driving surface, the barrier, and/or the lane marking(s). In some examples, the system(s) may use the information from the map to verify and/or update the information from the machine learning model(s). Additionally, or alternatively, in some examples, the system(s) use the information from the map to determine and/or verify whether a driving surface is divided. For example, the system(s) may verify that the driving surface is divided when both the algorithm(s) and the map indicate that the driving surface is divided, determine that the driving surface is divided when at least one of the algorithm(s) or the map indicate that the driving surface is divided, determine that the driving surface is not divided when at least one of the algorithm(s) or the map indicate that the driving surface is not divided, and/or verify that the driving surface is not divided when both the algorithm(s) and the map indicate that the driving surface is not divided.

The system(s) may then continue to perform one or more of these processes as the machine is navigating along the driving surface. For example, the system(s) may continue to obtain sensor data generated using the sensor(s), process the sensor data using the machine learning model(s) to determine information associated with the driving surface, and use the algorithm(s) to determine whether the driving surface is divided based at least on the information. Additionally, in some examples, the system(s) may use these determinations about whether the driving surface is divided to make a final determination about the driving surface. For example, the system(s) may determine that the driving surface is divided based at least on a threshold number of determinations (e.g., 50 determinations, etc.) and/or a threshold percentage of determinations (e.g., 95% of determinations, etc.) indicating that the driving surface is divided, which is described in more detail herein.

In some examples, the system(s) may then determine one or more operations for the machine to perform based at least on whether the driving surface is divided (e.g., includes a road separation). For instance, the system(s) may activate one or more semi-autonomous and/or autonomous functions of the machine when the driving surface includes a road separation or deactivate the semi-autonomous and/or autonomous function(s) of the machine when the driving surfaces does not include a road separation. As described herein, the semi-autonomous and/or autonomous function(s) may include, but is not limited to, automatic lane changing, automatic lane keeping and/or biasing, light activation and/or deactivation, blind spot monitoring, automatic emergency braking, and/or the any other autonomous or semi-autonomous function. Additionally, in some examples, the types of semi-autonomous and/or autonomous functions may depend on the geographic area associated with the driving surfaces. For example, specific geographic areas may allow for specific types of autonomous functions to be activated when driving surfaces include road separations while other types of geographic areas may allow for other types of autonomous functions to be activated when driving surfaces include road separations.

The examples herein describe machines navigating on driving surfaces that are located in different geographic areas. As described herein, a geographic area may include, but is not limited to, a city, a county, a state, a country, a continent, and/or any other type of geographic area. Additionally, a geographic area may be associated with respective rules and/or laws that govern how machines should navigate, such as based on the types of driving surfaces for which the machines are navigating. For instance, and as described in some examples, the rules and/or laws may define various semi-autonomous and/or autonomous functions that machines may activate and/or deactivate based on whether the machines are navigating on driving surfaces that are divided with road separations. For example, some geographic areas (e.g., some European countries) may allow machines to activate more semi-autonomous and/or autonomous functions while navigating on driving surfaces that are divided since these functions are safer to perform when there are road separations between opposing lanes of traffic.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Additionally, in some embodiments, the systems and methods described herein may be performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to detect road separations and/or determine whether driving surfaces are divided. These simulated operations may be used to test performance of the underlying algorithms, systems, and/or processes prior to deploying them in the real-world. In some instances, the simulation may be used to generate synthetic training data—e.g., training data including landmarks, features, objects, etc.—so that the synthetic training data (in addition to or alternatively from real-world data) may then be processed to perform driving surface type detections described herein.

In any example, such as where a simulation environment is used for testing, validation, training, etc., the simulation environment and/or associated training data may be rendered or otherwise generated using one or more light transport algorithms - such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to detect road separations and/or determine whether driving surfaces are divided within an environment, etc. that may be included in a visualization or mapping of an environment to aid a remote operator in controlling—or providing waypoints or other indications of control or navigation—an autonomous or semi-autonomous machine through an environment. For example, information relating to types of driving surfaces may be provided (e.g., via a visualization) to a remote operator to aid the remote operator in making navigation, planning, and/or control decisions for the (at least partially) remotely controlled vehicle or machine.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

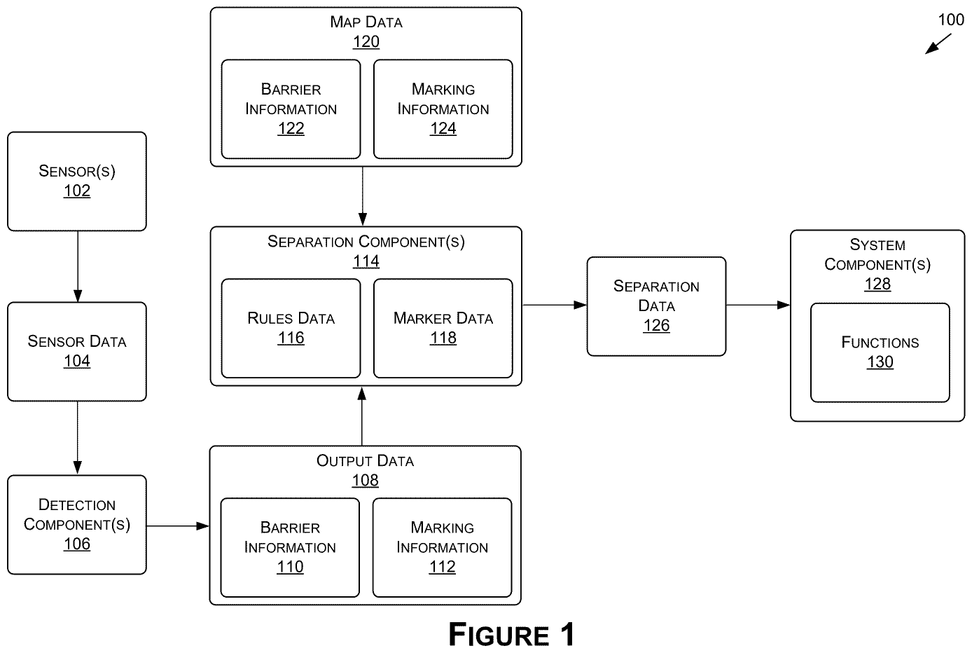

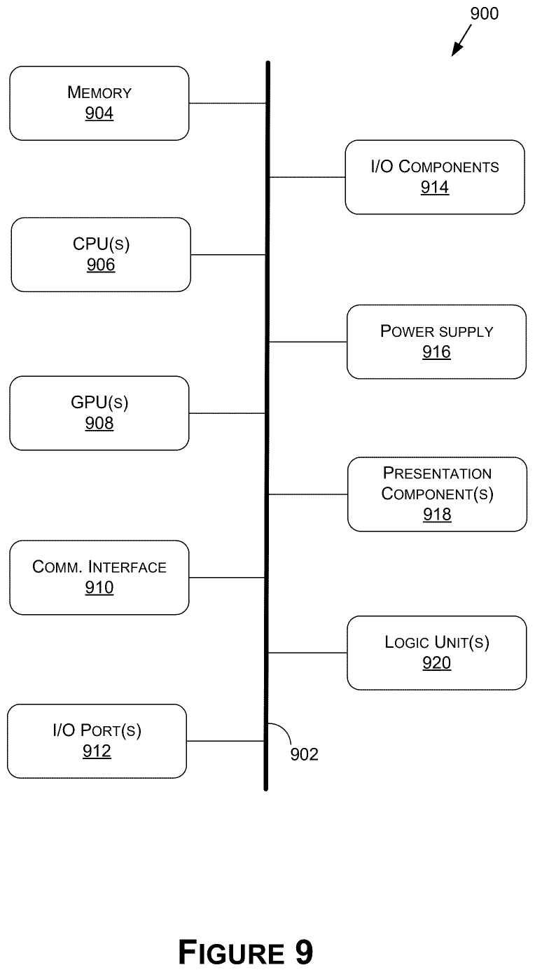

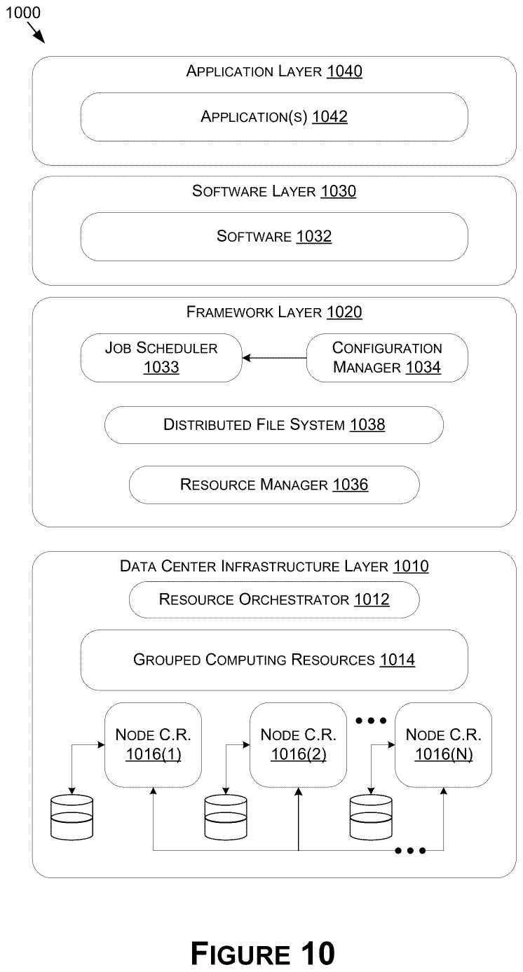

With reference to FIG. 1, FIG. 1 illustrates an example data flow diagram for a process 100 of determining whether driving surfaces include road separations, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 800 of FIGS. 8A-8D, example computing device 900 of FIG. 9, and/or example data center 1000 of FIG. 10.

For instance, the process 100 may include one or more sensors 102 generating sensor data 104. As described herein, the sensor data 104 may include, but is not limited to, image data obtained using one or more image sensors, LiDAR data obtained using one or more LiDAR sensors, RADAR data obtained using one or more RADAR sensors, and/or any other type of sensor data obtained using any other type of sensor. In some examples, the sensor(s) 102 may be included as part of and/or associated with one or more machines. For example, the sensor(s) 102 may be included as part of a semi-autonomous and/or autonomous vehicle (e.g., an example autonomous vehicle 802) that is navigating along a driving surface—such as a road (e.g., a rural road, a city road, a country road, a highway, a freeway, etc.), a parking area, and/or any other type of driving surface—located within an environment.

In some examples, a driving surface may include a road separation that divides the driving surface into two different segments, where such as driving surface may also be referred to as a “divided driving surface.” For example, a driving surface may include a road separation that divides the driving surface into two separate roads, where a first road includes one or more first lanes at which machines navigate in a first direction and a second road includes one or more second lanes at which machines navigate in a second, different direction. As described herein, a road separation may be created using one or more barriers, such as concrete slabs, guardrails, curbs, cones, a separation area (e.g., dirt, grass, etc.), and/or any other type of barrier. Additionally, and as described in more detail herein, whether a barrier constitutes as a road separator may depend on one or more factors, such as laws and/or rules associated with a geographic area for which the driving surface is located. For example, in some geographic areas a separating area may constitute as a road separation while in other geographic areas the separating area may not constitute a road separation.

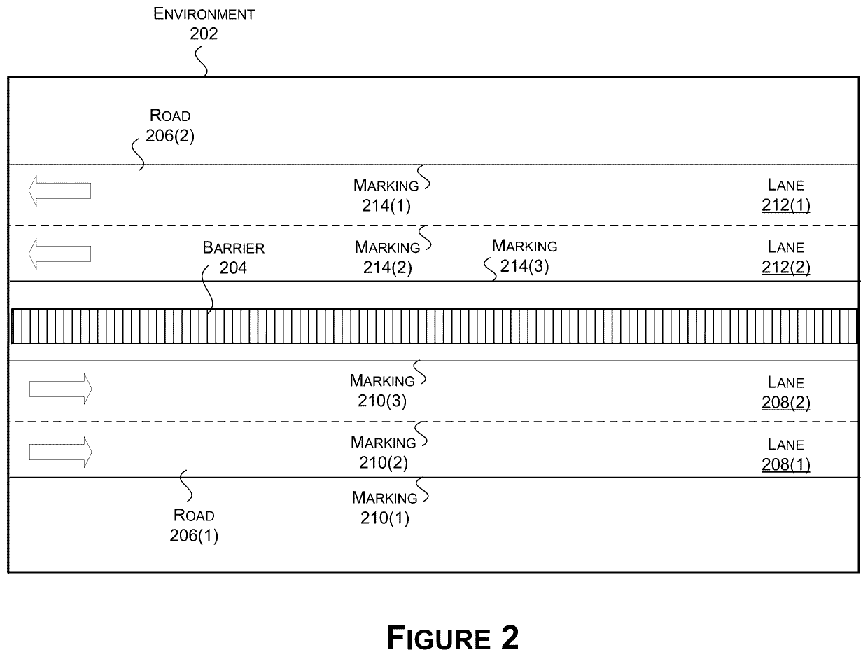

For instance, FIG. 2 illustrates an example of a divided driving surface that includes a road separation, in accordance with some embodiments of the present disclosure. As shown, in an environment 202, a barrier 204 may physically separate at least a first road 206(1) of the driving surface from a second road 206(2) of the driving surface. Additionally, the first road 206(1) may include at least lanes 208(1)-(2) (also referred to singularly as “lane 208” or in plural as “lanes 208”) that are associated with a first driving direction, as indicated by the arrows, and road markings 210(1)-(3) (also referred to singularly as “road marking 210” or in plural as “road markings 210”). The second road 206(2) may also include at least at least lanes 212(1)-(2) (also referred to singularly as “lane 212” or in plural as “lanes 212”) that are associated with a second driving direction, as indicated by the arrows, and road markings 214(1)-(3) (also referred to singularly as “road marking 214” or in plural as “road markings 214”).

Referring back to the example of FIG. 1, the process 100 may include one or more detection components 106 processing at least a portion of the sensor data 104 to generate output data 108. As described herein, the detection component(s) 106 may include and/or use one or more machine learning models, one or more neural networks, one or more classifiers, one or more algorithms, one or more modules, and/or any other type of processing component that is configured to perform at least a portion of the processing described herein. For instance, in some examples, the detection component(s) 106 may include and/or be part of a perception system of a machine, where the perception system is configured to detect and/or classify objects. As such, the output data 108 from the detection component(s) 106 may represent at least barrier information 110 associated with one or more barriers located within the environment and/or marking information 112 associated with one or more road markings located within the environment.

The barrier information 110 associated with a barrier may include, but is not limited to, a type of barrier, one or more dimensions associated with the barrier, and/or a location of the barrier. The type of barrier may include, but is not limited to, concrete slabs, a guardrail, a curb, cones, a separation area (e.g., a patch of dirt, etc.), and/or any other type of barrier that may be located within an environment. Additionally, the dimension(s) associated with the barrier may include, but is not limited to, a width, a length, a height, and/or any other dimensional information associated with the barrier. Furthermore, the location of the barrier may include, but is not limited to, a respective location, such as a distance between the machine and the barrier, coordinates of the barrier, such as the x-coordinate locations, the y-coordinate locations, and/or the z-coordinate locations, and/or any other type of location information associated with the barrier.

The marking information 112 associated with a road marking may include, but is not limited to, a type of road marking, a color of the road marking, and/or a location of the road marking. The type of road marking may include, but is not limited to, a double line marking, a single line marking, a dashed marking, a solid marking, a dotted marking, and/or any other type of road marking. As described herein, a type of road marking may indicate a one-way direction lane separation, such as a single line, or a two-way direction lane separation, such as a double yellow line. Additionally, the color of the road marking may include, but is not limited to, white, yellow, red, and/or any other color associated with road markings. Furthermore, the location of the road marking may include, but is not limited to, a respective distance, such as a distance between the machine and the road marking, coordinates of the road marking, such as the x-coordinate locations, the y-coordinate locations, and/or the z-coordinate locations, and/or any other type of location information associated with the road marking.

In some examples, the detection component(s) 106 (and/or another component, such as one or more separation components 114) may filter the output data 108 to verify that at least a barrier exists. For example, the detection component(s) 106 may analyze output data 108 generated over a period of time, such as two seconds (and/or any other period of time) at a working frame rate (e.g., 30 fps, 60 fps, etc.), and/or generated using a number of sensor representations, such as thirty frames (and/or any other number of frames), to verify the barrier. For a first example, the detection component(s) 106 may use the output data 108 over the period of time to determine a confidence value associated with the barrier. The detection component(s) 106 may then verify the barrier when the confidence value satisfies (e.g., is equal to or greater than) a threshold confidence value. For a second example, the detection component(s) 106 may use the output data 108 to determine a number of sensor representations and/or a percentage of sensor representations that indicate the barrier. The detection component(s) 106 may then verify the barrier when the number of sensor representations satisfies (e.g., is equal to or greater than) a threshold number and/or the percentage of sensor representations satisfies (e.g., is equal to or greater than) a threshold percentage.

The process 100 may then include the separation component(s) 114 processing at least the output data 108 to determine whether a road separation exists such that the driving surface includes a divided driving surface. As described herein, in some examples, determining whether a driving surface includes a divided driving surface may depend on one or more factors. For instance, the factor(s) may include laws and/or rules associated with a geographic area for which the driving surface is located, where the laws and/or rules may be represented by rules data 116. For a first example, some geographic areas may specify that any type of barrier that separates opposing lanes of travel includes a road separation such that a driving surface is divided. For a second example, some geographic areas may specify that specific types of barriers—such as barriers for which machines may not and/or are unable to traverse—include road separations such that a driving surface is divided. In such an example, types of barriers that machines may not traverse may include concrete slabs, guardrails, and/or any other types of barriers that machines are unable to navigate over. Still, for a third example, some geographic areas may specify that barriers include at least a set height include road separations such that a driving surface is divided.

Additionally, or alternatively, the factor(s) may include different types of road markings that may be detected, where the types of road markings may be represented by marker data 118. For instance, and as described in more detail herein, some types of road markings may be used when driving surfaces are not divided, such as road markings that separate opposing lanes of traffic (e.g., road marking that separate two-way traffic). For example, in some geographic areas, double yellow lines may be used to separate opposing lanes of traffic rather than a physical barrier that acts like a road separation. As such, these types of road markings may be represented by the marker data 118.

In some examples, the separation component(s) 114 may use one or more algorithms to determine whether a driving surface is divided using the output data 108. For a first example, the separation component(s) 114 may use the output data 108 to identify a closest barrier located on at least one side of the machine. The separation component(s) 114 may then determine that the driving surface is not divided when the type(s) of road marking(s) is located between the machine and the closest barrier or determine that the driving surface is divided when the type(s) of road marking(s) is not located between the machine and the closest barrier. For a second example, if the separation component(s) 114 determines that the output data 108 does not include the barrier information, such as there is no barrier located proximate to the driving surface, then the separation component(s) 114 may determine that the driving surface is not divided.

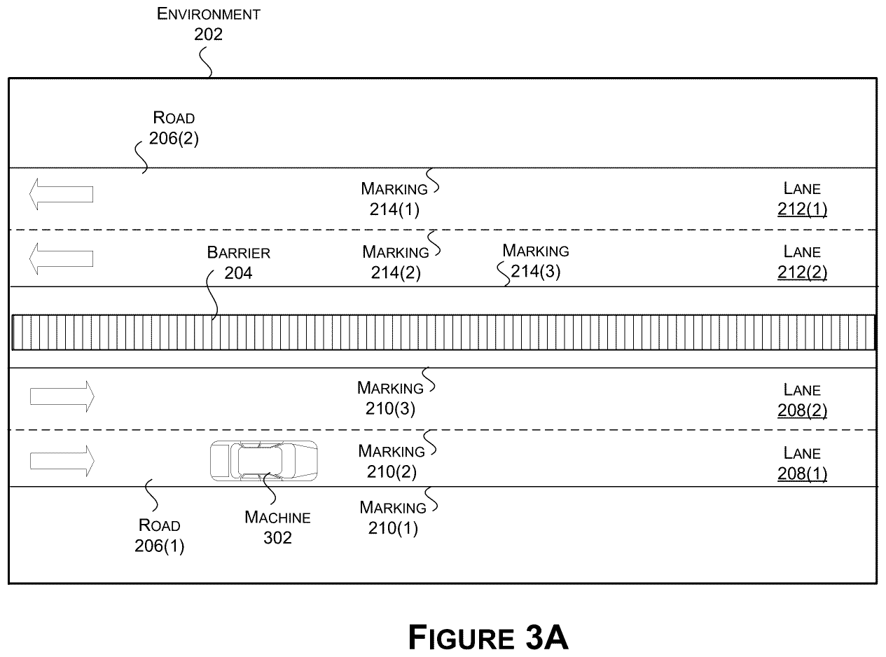

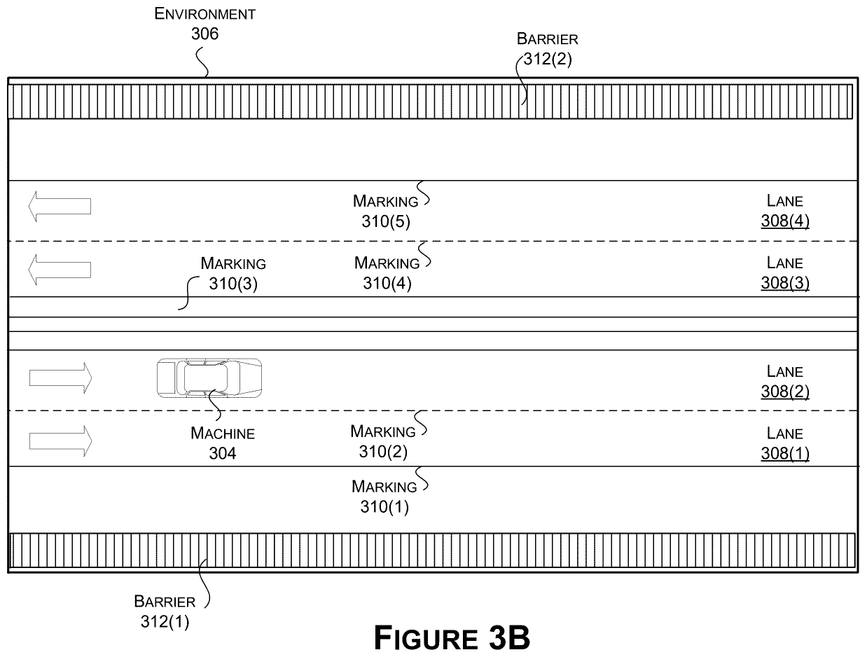

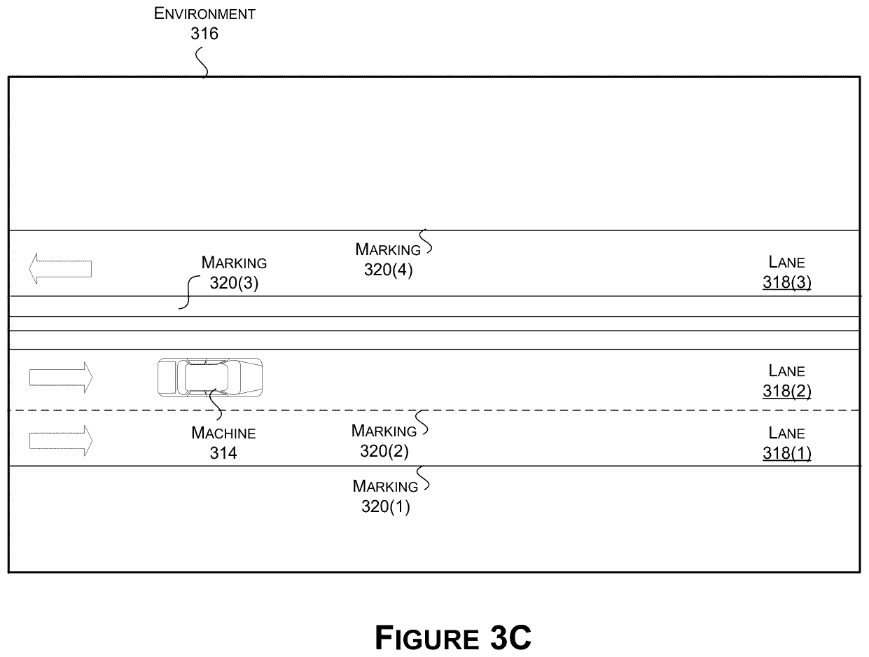

For more details, FIGS. 3A-3C illustrate examples of determining whether driving surfaces are divided with road separations, in accordance with some embodiments of the present disclosure. As shown by the example of FIG. 3A, a machine 302 may be navigating on the driving surface associate with the environment 202. While navigating, the detection component(s) 106 may process sensor data obtained using one or more sensors of the machine in order to determine information associated with the driving surface. For instance, the detection component(s) 106 may determine at least barrier information associated with the barrier 204 and marking information associated with the road markings 210. The separation component(s) 114 may then use this information to determine whether the driving surface is divided.

For instance, the separation component(s) 114 may determine that the barrier 204 includes the closest barrier to a side of the machine 302. The separation component(s) 114 may also determine that the road markings 210(2)-(3) are located between the machine 302 and the barrier 204. Additionally, the separation component(s) 114 may determine that the road markings 210(2)-(3) are not associated with specific types of road markings that separate two-way traffic. For example, the road marking 210(2) may include a single dashed line while the road marking 210(3) includes a single solid line. As such, the separation component(s) 114 may determine that the barrier 204 includes a road separation that separates the first road 206(1) from the second road 206(2).

In the example of FIG. 3B, a machine 304 may be navigating along a driving surface within an environment 306, where the driving surface includes at least lanes 308(1)-(4) (also referred to singularly as “lane 308” or in plural as “lanes 308”). As shown, the lanes 308(1)-(2) are associated with a first driving direction, as indicated by the arrows, while the lanes 308(3)-(4) are associated with a second driving direction, as also indicated by the arrows. The driving surface may further include road markings 310(1)-(5) (also referred to singularly as “road marking 310” or in plural as “road markings 310”) and barriers 312(1)-(2) (also referred to singularly as “barrier 312” or in plural as “barriers 312”). As such, the detection component(s) 106 may process at least sensor data obtained using one or more sensors of the machine 304 in order to determine information associated with the driving surface. For instance, the detection component(s) 106 may determine at least barrier information associated with the barriers 312 and marking information associated with the road markings 310.

The separation component(s) 114 may then use this information to determine whether the driving surface is divided. For instance, the separation component(s) 114 may determine that the barrier 312(2) includes the closest barrier to a left side of the machine 304. The separation component(s) 114 may also determine that the road markings 310(3)-(5) are located between the machine 302 and the barrier 312(2). Additionally, the separation component(s) 114 may determine that the road marking 310(3) is associated with a specific type of road marking that separates two-way traffic. For example, the road marking 310(3) may include a double line, such as a double yellow line, that is used to separate opposing lanes of traffic. As such, the separation component(s) 114 may determine that the barrier 312(2) does not include a road separation that separates the driving surface.

In some examples, the separation component(s) 114 may also determine that the barrier 312(1) includes the closest barrier to a right side of the machine 304. The separation component(s) 114 may also determine that the road markings 310(1)-(2) are located between the machine 302 and the barrier 312(1). Additionally, the separation component(s) 114 may determine that the road markings 310(1)-(2) are not associated with specific types of road markings that separate two-way traffic. For example, the road marking 310(1) may include a single solid line while the road marking 310(2) may include a single dashed line. As such, the separation component(s) 114 may determine that the barrier 312(1) potentially includes a road separation for the driving surface. However, the separation component(s) 114 may still determine that the driving surface is not divided based at least on the barrier 312(2) not including a road separation and/or the barrier 310(1) being located on an opposite side of the driving surface from which opposing traffic would be located.

In the example of FIG. 3C, a machine 314 may be navigating along a driving surface within an environment 316, where the driving surface includes at least lanes 318(1)-(3) (also referred to singularly as “lane 318” or in plural as “lanes 318”). As shown, the lanes 318(1)-(2) are associated with a first driving direction, as indicated by the arrows, while the lane 318(3) is associated with a second driving direction, as also indicated by the arrow. The driving surface may further include road markings 320(1)-(4) (also referred to singularly as “road marking 320” or in plural as “road markings 320”). As such, the detection component(s) 106 may process at least sensor data obtained using one or more sensors of the machine 314 in order to determine information associated with the driving surface. For instance, the detection component(s) 106 may determine at least marking information associated with the road markings 320.

The separation component(s) 314 may then use this information to determine whether the driving surface is divided. For instance, the separation component(s) 114 may determine that the driving surface is not divided based at least on the driving surface not including any barriers that could potentially include road separations.

Referring back to the example of FIG. 1, in some examples, the separation component(s) 114 may use additional data to determine whether a driving surface is divided using a road separation, such as map data 120 representing a map of the environment. For instance, the map—which may include a navigation map, a standard-deviation map, a high-definition map, and/or any other type of map—may indicate information associated with objects located within the environment, such as road features. For example, the map data 120 may represent at least barrier information 122 associated with one or more barriers located within the environment and/or marking information 124 associated with one or more road markings located within the environment. Similar to the barrier information 110, the barrier information 122 associated with a barrier may include, but is not limited to, a type of barrier, one or more dimensions associated with the barrier, and/or a location of the barrier. Additionally, similar to the marking information 112, the marking information 124 associated with a road marking may include, but is not limited to, a type of road marking, a color of the road marking, and/or a location of the road marking.

In some examples, the separation component(s) 114 may use the map data 120 to verify the output data 108 from the detection component(s) 106, such as the barrier information 110 and/or the marking information 112. For a first example, if the barrier information 110 indicates that a barrier includes a specific type of barrier, then the separation component(s) 114 may use the barrier information 122 to verify the type of barrier. For a second example, if the marking information 112 indicates that a road marking includes a specific type of road marking, then the separation component(s) 114 may use the marking information 124 to verify the type of road marking. Additionally, or alternatively, in some examples, the separation component(s) 114 may use the output data 108 from the detection component(s) 106 to verify the map data 120, such as the barrier information 122 and/or the marking information 124.

Additionally, or alternatively, in some examples, the separation component(s) 114 may use the map data 120 to determine whether a driving surface is divided with a road separation, such as by using one or more of the processes described herein with regard to the output data 108 and/or using labels from the map. For example, the map may include labels indicating whether driving surfaces are divided and/or whether driving surfaces are not divided. The separation component(s) 114 may then use the determination made using the output data 108 and/or the determination made using the map data 120 to make a final determination on whether the driving surface is divided. For a first example, if the determination made using the output data 108 and the determination made using the map data 120 both indicate that the driving surface is divided, then the separation component(s) 114 may make a final determination that the driving surface is divided. For a second example, if the determination made using the output data 108 and the determination made using the map data 120 both indicate that the driving surface is not divided, then the separation component(s) 114 may make a final determination that the driving surface is not divided.

For a third example, if one of the determination made using the output data 108 and the determination made using the map data 120 indicates that the driving surface is divided, then the separation component(s) 114 may make a final determination that the driving surface is divided. Still, for a fourth example, if one of the determination made using the output data 108 and the determination made using the map data 120 indicates that the driving surface is not divided, then the separation component(s) 114 may make a final determination that the driving surface is not divided. In these last two examples, the separation component(s) 114 may rely on one of the determinations when the determinations differ from one another. For example, the separation component(s) 114 may rely on the determination made using the output data 108 since that determination is more likely correct as compared to the determination made using the map data 120.

The process 100 may then include the separation component(s) 114 generating and/or outputting separation data 126 indicating whether the driving surface is divided using a road separation. In some examples, the separation data 126 may include additional information associated with the driving surface, such as a location of the road separation, a distance to the road separation, a type of barrier associated with the road separation, dimensions associated with the barrier, and/or any other information. Additionally, in some examples, this portion of the process 100 may repeat in order to verify whether the driving surface is divided with the road separation.

For example, the separation component(s) 114 may continue analyzing output data 108 generated over a period of time, such as two seconds (and/or any other period of time), and/or generated using a number of sensor representations, such as thirty frames (and/or any other number of frames), to determine whether the driving surface is divided. For a first example, the separation component(s) 114 may use the output data 108 over the period of time to determine a confidence value associated with the driving surface being divided. The separation component(s) 114 may then verify that the driving surface is divided when the confidence value satisfies (e.g., is equal to or greater than) a threshold confidence value. For a second example, the separation component(s) 114 may use the output data 108 to determine a number of sensor representations and/or a percentage of sensor representations that indicate the driving surface is divided. The separation component(s) 114 may then verify that the driving surface is divided when the number of sensor representations satisfies (e.g., is equal to or greater than) a threshold number and/or the percentage of sensor representations satisfies (e.g., is equal to or greater than) a threshold percentage.

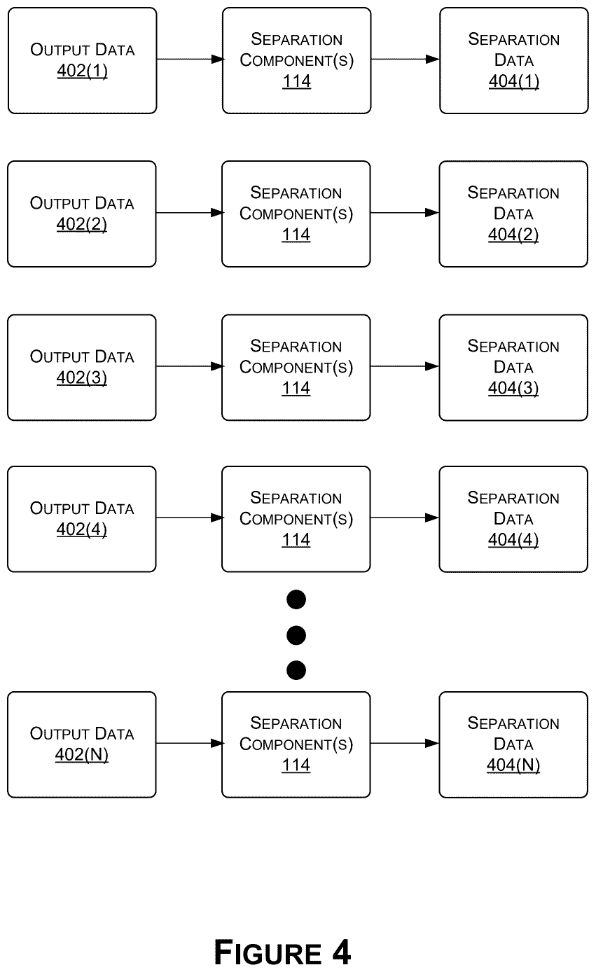

For instance, FIG. 4 illustrates an example of determining whether one or more driving surfaces include one or more road separations over a period of time, in accordance with some embodiments of the present disclosure. As shown, the separation component(s) 114 may process output data 402(1)-(N) (also referred to as “output data 402”) generated at different time instances in order to generate separation data 404(1)-(N) (also referred to as “separation data 404”) indicating whether the driving surface(s) is divided with the road separation(s). In some examples, the instances of the output data 402 may be associated with sensor representations, such as frames and/or groups of frames of image data. In some examples, the instances of the output data 402 may be generated at specific time intervals, such as every second (and/or any other time interval).

The separation component(s) 114 may also use the separation data 404 to make a final determination of whether a driving surface is divided. For a first example, the separation component(s) 114 may update a confidence value associated with the driving surface, where the confidence value increased each time it is determined that the driving surface is divided or decreased each time it is determined that the driving surface is not divided. The separation component(s) 114 may then make a final determination that the driving surface is divided when the confidence value satisfies a threshold value. For a second example, the separation component(s) 114 may determine a percentage of the determinations that indicate that the driving surface is divided. The separation component(s) 114 may then make a final determination that the driving surface is divided when the percentage satisfies a threshold percentage. While these are just two example techniques for how the separation component(s) 114 may use the separation data 404 to make a final determination on whether a driving surface is divided, in other examples, the separation component(s) 114 may use additional and/or alternative techniques.

Referring back to the example of FIG. 1, the process 100 may then include one or more system components 128 using the separation data 126 to perform one or more operations. For instance, in some examples, the system component(s) 128 may use the separation data 126 to determine one or more semi-autonomous and/or autonomous functions 130 of the machine to activate and/or one or more semi-autonomous and/or autonomous functions 130 of the machine to deactivate based at least on whether the driving surface is divided using a road separation. As described herein, in some examples, the semi-autonomous and/or autonomous functions 130 may include, but are not limited to, automatic lane changing, automatic lane keeping and/or biasing, light activation and/or deactivation, blind spot monitoring, automatic emergency braking, and/or the any other semi-autonomous and/or autonomous functions. Additionally, in some examples, the semi-autonomous and/or autonomous functions 130 may be associated with various autonomous levels, which are described in more detail herein.

For a first example, the system component(s) 128 may activate automatic lane changing of a machine when navigating on a driving surface that is divided with a road separation while deactivating the autonomous lane changing of the machine when navigating on another driving surface that is not divided with a road separation. For a second example, the system component(s) 128 may activate lane keeping on a machine when navigating on a driving surface that is divided with a road separation while deactivating the lane keeping on the machine when navigating on another driving surface that is not divided with a road separation. Still, for a third example, the system component(s) 128 may activate functions associated with Level 5 autonomous driving for a machine when navigating on a driving surface that is divided by a road separation while only activating functions associated with Level 2 autonomous driving for the machine when navigating on another driving surface that is not divided by a road separation.

In some examples, the system component(s) 128 may determine the semi-autonomous and/or autonomous functions 130 to activate and/or deactivate based at least on one or more factors. For instance, the system component(s) 128 may determine the semi-autonomous and/or autonomous functions 130 to activate and/or deactivate based at least on one or more laws and/or rules associated with a geographic area at which the machine is navigating. For a first example, a first geographic area may allow for machines to navigate using a semi-autonomous and/or autonomous function 130 (e.g., automatic lane changing) on all driving surfaces while a second geographic area may allow for machines to navigate using the semi-autonomous and/or autonomous function 130 only on driving surfaces that are divided. For a second example, a first geographic area may allow for machines to navigate using semi-autonomous and/or autonomous functions 130 associated with Level 5 autonomous driving while navigating on all driving surfaces while a second geographic area may allow for machines to navigate using the semi-autonomous and/or autonomous functions 130 associated with Level 5 autonomous driving only on driving surfaces that are divided.

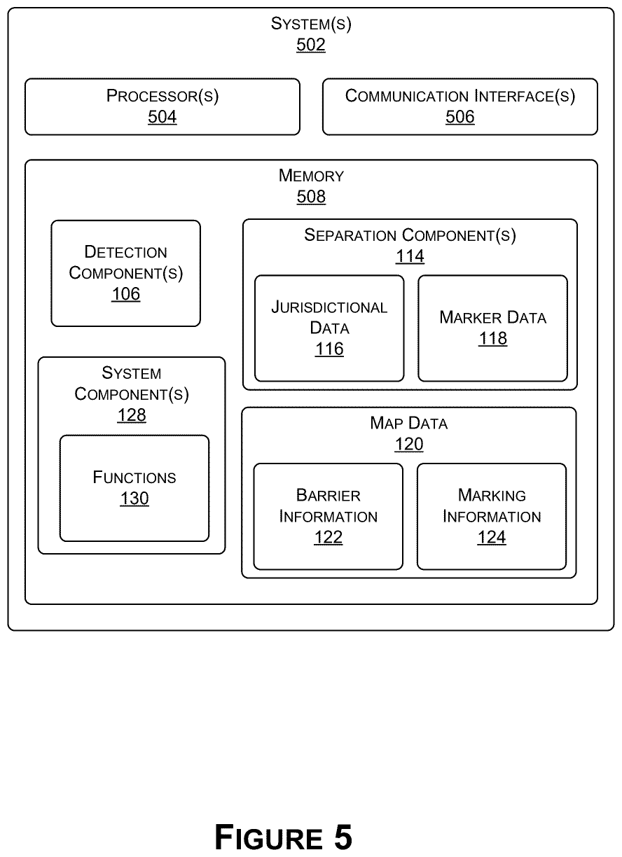

FIG. 5 illustrates an example of one or more systems 502 that may perform at least a portion of the processes described herein, in accordance with some embodiments of the present disclosure. In some examples, the system(s) 502 may be included as part of one or more machines, such as one or more semi-autonomous and/or autonomous machines (e.g., an example autonomous vehicle 800). In some examples, the system(s) 502 may be remote from and communicate with one or more machines. Still, in some examples, the system(s) 502 may be associated with another type of technology, such as a simulation system.

As shown, the system(s) 502 may include one or more processors 504 (which may include, and/or be similar to, a CPU(s) 806, a GPU(s) 808, a processor(s) 810, a CPU(s) 818, a GPU(s) 820, a CPU(s) 906, and/or a GPU(s) 908), an SoC(s) 804, an accelerator(s) 814, one or more communication interfaces 506 (which may include, and/or be similar to, a network interface 828 and/or a communication interface 910), and memory 508 (which may include, and/or be similar to, a memory 904). Additionally, the memory 508 may store and/or the processor(s) 504 may execute the detection component(s) 106, the separation component(s) 114, and/or the system component(s) 128 to perform one or more of the processes described herein.

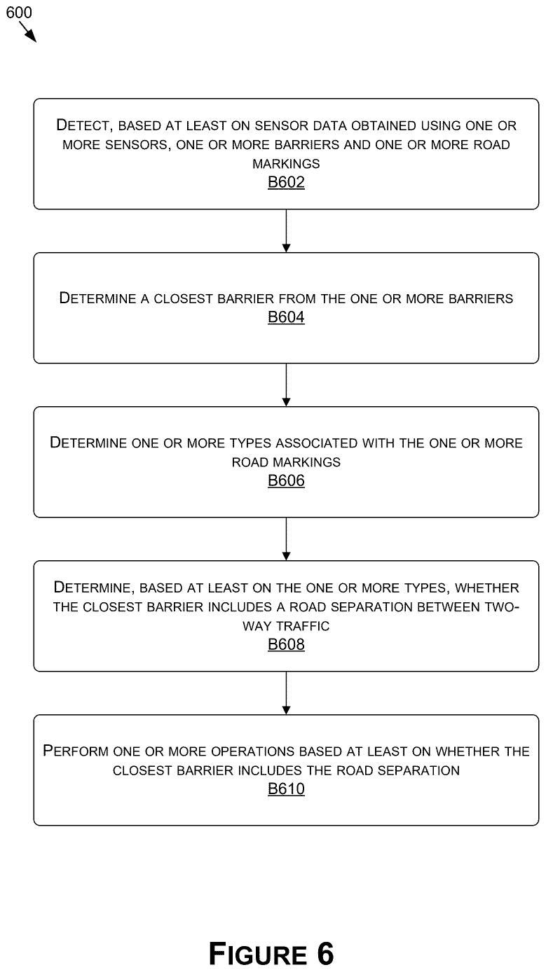

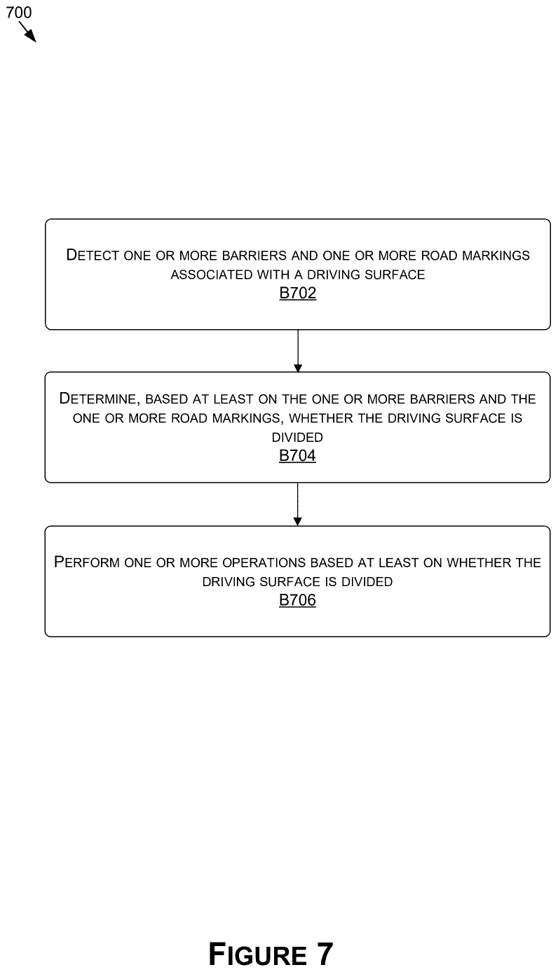

Now referring to FIGS. 6-7, each block of methods 600 and 700, described herein, comprises a computing process that may be performed using any combination of hardware, firmware, and/or software. For instance, various functions may be carried out by a processor executing instructions stored in memory. The methods 600 and 700 may also be embodied as computer-usable instructions stored on computer storage media. The methods 600 and 700 may be provided by a standalone application, a service or hosted service (standalone or in combination with another hosted service), or a plug-in to another product, to name a few. In addition, these methods 600 and 700 described, by way of example, with respect to FIG. 1. However, these methods 600 and 700 may additionally or alternatively be executed by any one system, or any combination of systems, including, but not limited to, those described herein.

FIG. 6 illustrates a flow diagram showing a method 600 for identifying a road separation associated with a driving surface, in accordance with some embodiments of the present disclosure. The method 600, at block B602, may include detecting, based at least on sensor data obtained using one or more sensors, one or more barriers and one or more road markings. For instance, the detection component(s) 106 may process the sensor data 104 obtained using the sensor(s) 102 of a machine. Based at least on the processing, the detection component(s) 106 may generate the output data 108 representing at least the barrier information 110 associated with the barrier(s) and the marking information 112 associated with the road marking(s) corresponding to the driving surface.

The method 600, at block B604, may include determining a closest barrier from the one or more barriers. For instance, the separation component(s) 114 may process the output data 108 to determine at least the closest barrier to the machine. In some examples, the closest barrier is with respect to a side of the machine, such as a side for which oncoming traffic may be located. In some examples, the separation component(s) 114 may determine closest barriers located on multiple sides of the machine.

The method 600, at block B606, may include determining one or more types associated with the one or more road markings. For instance, the separation component(s) 114 may process the output data 108 to determine the type(s) associated with the road marking(s). As described herein, the type(s) may be associated with one-way traffic markings, such as single lane dividers (and/or any other type), and two-way traffic markings, such as double yellow lane dividers (and/or other type). In some examples, the separation component(s) 114 may determine the type(s) for the road marking(s) that is located between the machine and the closest barrier.

The method 600, at block B608, may include determining, based at least on the one or more types, whether the closest barrier includes a road separation between two-way traffic. For instance, the separation component(s) 114 may determine whether the closest barrier includes the road separation based at least on the type(s). As described herein, the separation component(s) 114 may use one or more algorithms to make the determination. For example, the separation component(s) 114 may determine that the closest barrier includes the road separation when the type(s) includes one or more first types, such as one-way traffic markings, or determine that the closest barrier does not include the road separation when the type(s) includes one or more second types, such as two-way traffic.

The method 600, at block B610, may include performing one or more operations based at least on whether the closest barrier includes the road separation. For instance, the system component(s) 128 may determine the operation(s) based at least on whether the closest barrier includes the road separation. As described herein, in some examples, the operation(s) may include activating one or more semi-autonomous and/or autonomous functions 130 based at least on the closest barrier including the road separation and/or deactivating one or more semi-autonomous and/or autonomous functions 130 based at least on the closest barrier not including the road separation.

FIG. 7 illustrates a flow diagram showing a method 700 for determining whether a driving surface is divided, in accordance with some embodiments of the present disclosure. The method 700, at block B702, may include detecting one or more barriers and one or more road markings associated with a driving surface. For instance, the separation component(s) 114 may detect the barrier(s) and the road marking(s) associated with the driving surface. In some examples, the separation component(s) 114 may use the output data 108 to detect the barrier(s) and/or the road marking(s). Additionally, or alternatively, in some examples, the separation component(s) 114 may use the map data 120 to detect the barrier(s) and/or the road marking(s). For example, the separation component(s) 114 may detect the barrier(s) using the barrier information 110 and/or the barrier information 122 and/or the separation component(s) 114 may detect the road marking(s) using the marking information 112 and/or the marking information 124.

The method 700, at block B704, may include determining, based at least on the one or more barriers and the one or more road markings, whether the driving surface is divided. For instance, the separation component(s) 114 may determine whether the driving surface is divided based at least on the barrier(s) and the road marking(s). As described herein, the separation component(s) 114 may use one or more algorithms to make the determination. For example, the separation component(s) 114 may determine that the driving surface is divided by a road separation when one or more of the road marking(s) between the machine and a barrier include one or more first types, such as one-way traffic markings, or determine that the driving surface is not divided by a road separation when the road marking(s) between the machine and the barrier include one or more second types, such as two-way traffic markings.

The method 700, at block B706, may include performing one or more operations based at least on whether the driving surface is divided. For instance, the system component(s) 128 may determine the operation(s) based on whether the driving surface is divided by a road separation. As described herein, in some examples, the operation(s) may include activating one or more semi-autonomous and/or autonomous functions 130 based at least on the driving surface being divided and/or deactivating one or more semi-autonomous and/or autonomous functions 130 based at least on the driving surface not being divided.

### Example Autonomous Vehicle

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LIDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF 64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 812 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LIDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LIDAR sensor(s) 864. The LIDAR sensor(s) 864 may be used for object and pedestrian detection, emergency braking, collision avoidance, and/or other functions. The LIDAR sensor(s) 864 may be functional safety level ASIL B. In some examples, the vehicle 800 may include multiple LIDAR sensors 864 (e.g., two, four, six, etc.) that may use Ethernet (e.g., to provide data to a Gigabit Ethernet switch).

In some examples, the LIDAR sensor(s) 864 may be capable of providing a list of objects and their distances for a 360-degree field of view. Commercially available LIDAR sensor(s) 864 may have an advertised range of approximately 800 m, with an accuracy of 2 cm-3 cm, and with support for a 800 Mbps Ethernet connection, for example. In some examples, one or more non-protruding LIDAR sensors 864 may be used. In such examples, the LIDAR sensor(s) 864 may be implemented as a small device that may be embedded into the front, rear, sides, and/or corners of the vehicle 800. The LIDAR sensor(s) 864, in such examples, may provide up to a 120-degree horizontal and 35-degree vertical field-of-view, with a 200 m range even for low-reflectivity objects. Front-mounted LIDAR sensor(s) 864 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 800. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LIDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(H) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1033, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1033 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1033. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE CLAUSES

A: A method comprising: detecting, based at least on sensor data obtained using one or more sensors of a machine, at least one or more road barriers and one or more road markings; determining a closest road barrier of the one or more road barriers; determining, based at least on the one or more road markings, that the closest road barrier includes a road separation between one or more first lanes associated with a first direction that the machine is traveling and one or more second lanes associated with a second direction different from the first direction; and performing one or more autonomous or semi-autonomous functions associated with the machine based at least on the road barrier including the road separation.

B: The method of paragraph A, further comprising: determining a type of barrier associated with the closest road barrier; and determining, based at least on the type of barrier, that the machine is unable to navigate over the closest road barrier, wherein the determining that the closest road barrier includes the road separation is further based at least on the machine being unable to navigate over the closest road barrier.

C: The method of either paragraph A or paragraph B, further comprising: determining at least a road marking from the one or more road markings that is located between the machine and the closest road barrier; and determining a type of marking associated with the road marking, wherein the determining that the closest road barrier includes the road separation is based at least on the type of marking associated with the road marking.

D: The method of paragraph C, further comprising: determining that the type of marking is associated with one-way traffic, wherein the determining that the closest road barrier includes the road separation is based at least on the type of marking being associated with the one-way traffic.

E: The method of any one of paragraphs A-D, further comprising: detecting, based at least on second sensor data obtained using the one or more sensors of the machine, at least one or more second road barriers and one or more second road markings; determining the closest road barrier from the one or more second road barriers; and verifying that the closest road barrier includes the road separation based at least on the one or more second road markings, wherein the performing the one or more autonomous functions is based at least on the verifying the closest road barrier.

F: The method of any one of paragraphs A-E, wherein the performing the one or more autonomous or semi-autonomous functions occurs at a first time, and wherein the method further comprises: detecting, based at least on second sensor data obtained using the one or more sensors of the machine, at least one or more second road barriers and one or more second road markings; determining, based at least on the one or more second road markings, that the one or more second road barriers do not include a second road separation; and based at least on the one or more second road barriers not including the second road separation, refraining from performing the one or more autonomous or semi-autonomous functions at a second time.

G: The method of any one of paragraphs A-F, wherein the performing the one or more autonomous or semi-autonomous functions associated with the machine comprises at least one of: causing the machine to autonomously switch lanes; causing the machine to autonomously maintain a lane; causing the machine to autonomously activate or deactivate one or more lights; or causing the machine to autonomously use emergency braking.

H: A system comprising: one or more processors to: detect, based at least on sensor data obtained using one or more sensors of a machine, at least one or more barriers and one or more surface markings; determine, based at least on the one or more surface markings, whether at least a barrier of the one or more barriers is associated with a surface separation; and cause the machine to perform one or more operations based at least on whether the barrier is associated with the surface separation.

I: The system of paragraph H, wherein the one or more processors are further to: determine a closest barrier from the one or more barriers, wherein the determination of whether the barrier is associated with the surface separation comprises determining, based at least on the one or more surface markings, whether the closest barrier is associated with the surface separation.

J: The system of paragraph I, wherein the one or more processors are further to: determine at least a portion of the one or more surface markings that are located between the machine and the closest barrier, wherein whether the closest barrier is associated with the surface separation is determined based at least on the at least the portion of the one or more surface markings.

K: The system of any one of paragraphs H-J, wherein the one or more processors are further to: determine a type of barrier associated with the barrier, wherein whether the barrier is associated with the surface separation is further determined based at least on the type of barrier.

L: The system of paragraph K, wherein the type of barrier includes at least one of: a first type of barrier that the machine is unable to navigate over; or a second type of barrier that the machine is able to navigate over.

M: The system of any one of paragraphs H-L, wherein the one or more processors are further to: determine that at least a surface marking from the one or more surface markings is associated with two-way traffic, wherein the determination of whether the barrier is associated with the surface marking comprises determining, based at least on the surface marking being associated with the two-way traffic, that the barrier is not associated with the surface separation.

N: The system of any one of paragraphs H-M, wherein the one or more processors are further to: determine that the one or more surface markings are associated with one-way traffic, wherein the determination of whether the barrier is associated with the surface marking comprises determining, based at least on the one or more surface markings being associated with the one-way traffic, that the barrier is associated with the surface separation.

O: The system of any one of paragraphs H-N, wherein the one or more processors are further to: determine, based at least on a map, information associated with at least one of the barrier or the one or more surface markings, wherein whether the barrier is associated with the surface separation is further determined based at least on the information.

P: The system of any one of paragraphs H-O, wherein the one or more processors are further to: detect, based at least on second sensor data obtained using the one or more sensors of the machine, at least one or more second barriers and one or more second surface markings; and verify whether the barrier is associated with the surface separation based at least on the one or more second barriers and the one or more second surface markings.

Q: The system of any one of paragraphs H-P, wherein the performance of the one or more operations comprises at least one of: causing one or more semi-autonomous or autonomous functions of the machine to activate based at least on the barrier being associated with the surface separation; or causing the one or more semi-autonomous or autonomous functions of the machine to deactivate based at least on the barrier not being associated with the surface separation.

R: The system of any one of paragraphs H-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

S: An autonomous or semi-autonomous machine comprising: one or more central processing units (CPUs); one or more graphics processing units (GPUs); one or more hardware accelerators; and one or more external sensors having fields of view or sensory fields external to the autonomous or semi-autonomous machine, wherein the autonomous or semi-autonomous machine performs one or more operations according to a current road separation state of a driving surface, wherein the road separation state is determined based at least on detection results corresponding to one or more barriers and one or more road markings associated with the driving surface as identified using sensor data obtained using at least one external sensor of the one or more external sensors.

T: The autonomous or semi-autonomous machine of paragraph S, wherein the autonomous or semi-autonomous machine includes or is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
detecting, based at least on sensor data obtained using one or more sensors of a machine, at least one or more road barriers and one or more road markings;
determining a closest road barrier of the one or more road barriers;
determining, based at least on the one or more road markings, that the closest road barrier includes a road separation between one or more first lanes associated with a first direction that the machine is traveling and one or more second lanes associated with a second direction different from the first direction; and
performing one or more autonomous or semi-autonomous functions associated with the machine based at least on the road barrier including the road separation.

2. The method of claim 1, further comprising:
determining a type of barrier associated with the closest road barrier; and
determining, based at least on the type of barrier, that the machine is unable to navigate over the closest road barrier,
wherein the determining that the closest road barrier includes the road separation is further based at least on the machine being unable to navigate over the closest road barrier.

3. The method of claim 1, further comprising:
determining at least a road marking from the one or more road markings that is located between the machine and the closest road barrier; and
determining a type of marking associated with the road marking,
wherein the determining that the closest road barrier includes the road separation is based at least on the type of marking associated with the road marking.

4. The method of claim 3, further comprising:
determining that the type of marking is associated with one-way traffic,
wherein the determining that the closest road barrier includes the road separation is based at least on the type of marking being associated with the one-way traffic.

5. The method of claim 1, further comprising:
detecting, based at least on second sensor data obtained using the one or more sensors of the machine, at least one or more second road barriers and one or more second road markings;
determining the closest road barrier from the one or more second road barriers; and
verifying that the closest road barrier includes the road separation based at least on the one or more second road markings,
wherein the performing the one or more autonomous functions is based at least on the verifying the closest road barrier.

6. The method of claim 1, wherein the performing the one or more autonomous or semi-autonomous functions occurs at a first time, and wherein the method further comprises:
detecting, based at least on second sensor data obtained using the one or more sensors of the machine, at least one or more second road barriers and one or more second road markings;
determining, based at least on the one or more second road markings, that the one or more second road barriers do not include a second road separation; and
based at least on the one or more second road barriers not including the second road separation, refraining from performing the one or more autonomous or semi-autonomous functions at a second time.

7. The method of claim 1, wherein the performing the one or more autonomous or semi-autonomous functions associated with the machine comprises at least one of:
causing the machine to autonomously switch lanes;
causing the machine to autonomously maintain a lane;
causing the machine to autonomously activate or deactivate one or more lights; or
causing the machine to autonomously use emergency braking.

8. A system comprising:
one or more processors to:
detect, based at least on sensor data obtained using one or more sensors of a machine, at least one or more barriers and one or more surface markings;
determine, based at least on the one or more surface markings, whether at least a barrier of the one or more barriers is associated with a surface separation; and
cause the machine to perform one or more operations based at least on whether the barrier is associated with the surface separation.

9. The system of claim 8, wherein the one or more processors are further to:
determine a closest barrier from the one or more barriers,
wherein the determination of whether the barrier is associated with the surface separation comprises determining, based at least on the one or more surface markings, whether the closest barrier is associated with the surface separation.

10. The system of claim 9, wherein the one or more processors are further to:
determine at least a portion of the one or more surface markings that are located between the machine and the closest barrier,
wherein whether the closest barrier is associated with the surface separation is determined based at least on the at least the portion of the one or more surface markings.

11. The system of claim 8, wherein the one or more processors are further to:
determine a type of barrier associated with the barrier,
wherein whether the barrier is associated with the surface separation is further determined based at least on the type of barrier.

12. The system of claim 11, wherein the type of barrier includes at least one of:
a first type of barrier that the machine is unable to navigate over; or
a second type of barrier that the machine is able to navigate over.

13. The system of claim 8, wherein the one or more processors are further to:
determine that at least a surface marking from the one or more surface markings is associated with two-way traffic,
wherein the determination of whether the barrier is associated with the surface marking comprises determining, based at least on the surface marking being associated with the two-way traffic, that the barrier is not associated with the surface separation.

14. The system of claim 8, wherein the one or more processors are further to:
determine that the one or more surface markings are associated with one-way traffic,
wherein the determination of whether the barrier is associated with the surface marking comprises determining, based at least on the one or more surface markings being associated with the one-way traffic, that the barrier is associated with the surface separation.

15. The system of claim 8, wherein the one or more processors are further to:
determine, based at least on a map, information associated with at least one of the barrier or the one or more surface markings,
wherein whether the barrier is associated with the surface separation is further determined based at least on the information.

16. The system of claim 8, wherein the one or more processors are further to:
detect, based at least on second sensor data obtained using the one or more sensors of the machine, at least one or more second barriers and one or more second surface markings; and
verify whether the barrier is associated with the surface separation based at least on the one or more second barriers and the one or more second surface markings.

17. The system of claim 8, wherein the performance of the one or more operations comprises at least one of:
causing one or more semi-autonomous or autonomous functions of the machine to activate based at least on the barrier being associated with the surface separation; or
causing the one or more semi-autonomous or autonomous functions of the machine to deactivate based at least on the barrier not being associated with the surface separation.

18. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. An autonomous or semi-autonomous machine comprising:
one or more central processing units (CPUs);
one or more graphics processing units (GPUs);
one or more hardware accelerators; and
one or more external sensors having fields of view or sensory fields external to the autonomous or semi-autonomous machine,
wherein the autonomous or semi-autonomous machine performs one or more operations according to a current road separation state of a driving surface, wherein the road separation state is determined based at least on detection results corresponding to one or more barriers and one or more road markings associated with the driving surface as identified using sensor data obtained using at least one external sensor of the one or more external sensors.

20. The autonomous or semi-autonomous machine of claim 19, wherein the autonomous or semi-autonomous machine includes or is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
